(19) United States
(12) Patent Application Publication
(10) Pub. No.: US 2009/0068309 A1
(43) Pub. Date: Mar. 12, 2009

(54) GLUTEN-FREE BEER AND METHOD FOR MAKING THE SAME

(75) Inventor: Russell J. Klisch, Shorewood, WI (US)

Correspondence Address: MICHAEL BEST & FRIEDRICH LLP, 100 E WISCONSIN AVENUE, Suite 3300, MILWAUKEE, WI, 53202, US

(73) Assignee: LAKEFRONT BREWERY, INC., Milwaukee, WI (US)

(21) Appl. No.: 12/279,278

(22) PCT Filed: Oct. 14, 2006
(86) PCT No.: PCT/US2006/040338

§ 371 Date: Oct. 20, 2008

Related U.S. Application Data
(60) Provisional application No. 60/779,603, filed on Mar. 6, 2006.

(51) Int. Cl. C12C 12/00; C12C 11/00

(52) U.S. Cl. 426/16

(57) ABSTRACT

A gluten-free beer derived from fermentable sugars obtained from an enzymatic reaction with gluten-free cereals and grains, and a method of making a gluten-free beer that includes dissolving enzyme-produced fermentable sugars derived from gluten-free cereals and grains in water to produce an aqueous solution, adding a yeast nutrient, a protein coagulant and hops to the aqueous solution to form an aqueous brew, and fermenting the aqueous brew by the addition of yeast to produce a gluten-free beer.

### CROSS-REFERENCE TO RELATED APPLICATIONS

This application claims priority to U.S. Provisional Application No. 60/779,603 filed Mar. 6, 2006, which is incorporated herein by reference.

### BACKGROUND

Beer is commonly made from wheat, barley and/or malt products. These ingredients contain gluten which contributes to the texture and flavor of the beer. However, certain segments of the population suffer from a dietary intolerance to gluten, known as Celiac disease, or Non-Tropical Sprue. When individuals with Celiac disease ingest gluten, the gluten damages the tiny hair-like projections in the small intestine and interferes with the small intestine's ability to absorb nutrients. The disease can cause extreme stomach discomfort, weight loss and fatigue. A recent study concluded that Celiac disease is much more widespread than previously thought. According to the National Digestive Disease Information Clearinghouse, it is believed that up to one percent of the U.S. population may have Celiac disease.

The only known treatment for Celiac disease is to completely remove gluten from the diet. Therefore, any foods containing wheat, barley or rye, such as pasta, beer and many packaged goods, must be avoided. The marketplace is currently in need of gluten-free products that would appeal to those with Celiac disease, as well as those just looking for an alternative beverage.

### SUMMARY

In one embodiment, the invention provides a method of making a gluten-free beer, the method comprising dissolving an enzyme-produced maltose syrup derived from at least one of rice, sorghum or combination thereof in water to produce an aqueous solution, adding a yeast nutrient, a protein coagulant and hops to the aqueous solution to form an aqueous brew, and fermenting the aqueous brew by the addition of yeast to produce a gluten-free beer.

In another embodiment, the invention provides a method of a method of making a gluten-free beer comprising dissolving an enzyme-produced maltose syrup derived from rice in water to produce a first aqueous solution and adding a yeast nutrient, a protein coagulant and hops to the aqueous solution to form a first aqueous brew, dissolving an enzyme-produced maltose syrup derived from sorghum in water to produce a second aqueous solution and adding a yeast nutrient, a protein coagulant and hops to the aqueous solution to form a second aqueous brew, combining the first aqueous brew and the second aqueous brew to produce a combined aqueous brew, and fermenting the combined aqueous brew by the addition of yeast to produce a gluten-free beer.

In a further embodiment, the invention provides a gluten-free beer derived from fermentation of an aqueous brew, the aqueous brew comprising maltose sorghum syrup and maltose rice syrup, a yeast nutrient, a protein coagulant, and hops.

In yet another embodiment, the invention provides a method of providing a gluten-free beer to an individual suffering from Celiac disease, the method comprising fermenting an aqueous brew comprising maltose sorghum syrup, maltose rice syrup, a yeast nutrient, a protein coagulant, and hops to produce a gluten-free beer, and providing the gluten-free beer to the individual suffering from Celiac disease.

In another embodiment, the invention provides a method of making a gluten-free beer comprising dissolving an enzyme-produced maltose syrup derived from rice in water to produce a first aqueous solution and adding a yeast nutrient, a protein coagulant and hops to the aqueous solution to form a first aqueous brew, dissolving an enzyme-produced maltose syrup derived from sorghum in water to produce a second aqueous solution and adding a yeast nutrient, a protein coagulant and hops to the aqueous solution to form a second aqueous brew, carrying out a first fermentation on each of the first aqueous brew and the second aqueous brew by the addition of yeast, combining the fermented first aqueous brew and the fermented second aqueous brew to produce a combined fermented aqueous brew, and carrying out a second fermentation on the combined first fermented aqueous brew to produce a gluten-free beer.

Other aspects of the invention will become apparent by consideration of the detailed description.

### DETAILED DESCRIPTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The present invention relates to compositions and methods used in the production of beverages. More particularly, the present invention relates to compositions and methods used in the production of gluten-free beer or substantially gluten-free beer. In other words, the beers of the present invention can be enjoyed by those suffering from Celiac disease.

The beer in the present invention is derived from aqueous brews comprising fermentable sugars from gluten-free cereals and grains, yeast nutrients, protein coagulants and hops. The aqueous brews are fermented into beer by the addition of yeast grown on, or derived from, non-gluten containing elements.

The fermentable sugars in the present invention are obtained from an enzymatic reaction with gluten-free cereals and grains such as, but not limited to, sorghum, rice, amaranth, quinoa, millet, buckwheat and corn. Suitable enzymes convert the starches in the cereals and grains into soluble fermentable sugars, such as maltose, glucose, maltotriose, sucrose and fructose. Suitable enzymes may include, but are not limited to, amylases (e.g., α-amylase and β-amylase), glucanases (e.g., β-glucanase), proteases and xylanase. In some embodiments, the enzymatic reaction mixture is strained to remove undesired components and the resulting sugar solution is boiled down to produce a syrup. Sources of fermentable sugars in the present invention include all-natural, enzyme-produced, high maltose syrups from white rice, brown rice and the starchy heads of grain sorghum. Commercially available high maltose syrups include, but are not limited to, Organic BriesSweet™ White Rice Syrup 45 DE High Maltose, BriesSweet™ f Brown Rice Syrup 45 DE High Maltose, and BriesSweet™ White Sorghum Syrup 45 DE High Maltose (available from Briess™ Malt & Ingredients Co., Chilton, Wis.). The aqueous brew may comprise fermentable sugars from one or more gluten-free cereals or grains. In one embodiment, the aqueous brew may comprise fermentable sugars from rice cereal. In another embodiment, the aqueous brew may comprise fermentable sugars from grain sorghum. In a further embodiment, the aqueous brew may comprise fermentable sugars from both rice cereal and grain sorghum, wherein the amount (by weight) of sugars derived from rice cereal may be less than 100%, as well as less than about 90%, about 80%, about 70%, about 60%, about 50%, about 40%, about 30%, about 20%, and about 10%. Particularly, the sugars derived from rice cereal can be about 40% to about 60%, and more particularly about 50%. The amount of sugars derived from sorghum grain may be less than 100%, as well as less than about 90%, about 80%, about 70%, about 60%, about 50%, about 40%, about 30%, about 20%, and about 10%. This includes embodiments where the ratio (by weight) of fermentable sugars derived from rice and sorghum ranges from about 2:8 to about 8:2, and more particularly from about 4:6 to about 6:4.

Enzymatic reactions with grain sorghum may produce undesirable acids that can effect the overall taste of a beer. In such cases, it may be desirable to use syrup from grain sorghum in which certain acids attributable to sharp flavors are removed. Therefore, in one embodiment, the aqueous brew may comprise fermentable sugars from grain sorghum in which certain acids, such as ferulic acid, are removed to mellow the flavor of the beer.

Yeast nutrients may be added to the aqueous brew to optimize yeast activity during the fermentation stage of the beer-making process. A variety of yeast nutrients known to those skilled in the art may be used. Examples of commercially available yeast nutrients include, but are not limited to, Yeastex® 61 and Yeastex® 82 (available from Kerry Bio-Science, Kilnagleary, Carrigaline, Co. Cork, Ireland), Yeastex (available from Crosby & Baker Ltd, Westport, Mass.) and AYF (available from Crosby & Baker Ltd, Westport, Mass.). The yeast nutrients may be used alone or in combination. The amount of yeast nutrient added to the aqueous brew depends upon such factors, for example, as the amount and type of yeast added during the fermentation process, as well as the type of yeast nutrient. This value can be readily ascertained by those skilled in the art.

Protein coagulants are typically added to remove free-floating proteins from the brew. Protein coagulants bind free-floating proteins that may exist in the aqueous brew into protein-coagulant masses. When the density of the protein-coagulant masses becomes greater than that of water, the protein-coagulant masses sink to the bottom of the aqueous brew, facilitating their removal. Thus, the protein coagulant acts as a clarifying agent to produce a more clear and brilliant beer. Suitable protein coagulants include Irish moss, carrageenan and a combination thereof. Examples of commercially available protein coagulants include Irish Moss, ABV Compac Powder, Whirlfloc-B (Breakbright) and Whirlfloc-T tablets (available from Crosby & Baker Ltd, Westport, Mass.). The protein coagulants may be used alone or in combination.

Hops comes from the flowers of Humulus lupulus and may be added to the aqueous brew to impart bitterness, contribute aromas that are flowery, citrus, fruity or herbal, and provide an antibiotic effect that favors the activity of brewer's yeast over less desirable microorganisms. Hop plants are grown all around the world in many different varieties. Examples of hops include, but are not limited to, Cascade, Challenger, Crystal, East Kent Goldings, Ultra, Fuggles, Hallertauer Hersbrucker, Hallertauer Mittelfrueh, Liberty, Lublin, Mt. Hood, Nz Hallertau Aroma, Progress, Saaz, Spalt, Strisselspalt, Styrian Goldings, Tettnang, Willamette, Brewer's Gold, Bullion, Centennial, Chinook, Cluster, Eroica, Galena, Northern Brewer, Nugget, Perle, and Pride of Ringwoud. It should be recognized by one skilled in the art that a variety of hops may be employed in this invention, either individually or in combination. Particularly suitable hops include Hexahop Gold Hop Extract and Tetrahop Gold Hop Extract (available from JOHN I. HAAS, Inc., Yakima, Wash.) and Cascade (available from Hop Union, Yakima, Wash.). The hop requirement in normal beer brewing operations is about 0.5 pounds per 31 gallons of beer. However, it should be recognized by those skilled in the art that the amount of hops added will vary depending upon such factors as the source of hops, the form in which it is available (e.g., plant, syrup, etc.), and the desired taste and aroma of the resultant beer.

Any yeast grown on, or derived from, non-gluten containing elements is suitable for the present invention. Such yeast may include Ale yeast, such as Saccharomyces cerevisiae, and Lager yeast, such as Saccharomyces uvarum, grown on gluten-free materials such as molasses. Suitable commercially available yeasts may include Fermentis SafAle K-97, Fermentis SafAle S-04, Fermentis SafAle US-56, Fermentis SafBrew S-33, Fermentis SafBrew T-58, Nottingham Ale Yeast, Fermentis SafLager S-23, Fermentis SafLager S-189 and Fermentis SafLager W-34/70 (available from Crosby & Baker Ltd, Westport, Mass.). The yeasts may be used alone or in combination. The amount of yeast added to the aqueous brew will vary but may fall in the range of about 500,000 to about 1,500,000 cells/ml of unfermented wort/° P, particularly about 750,000 to about 1,250,000 cells/ml of unfermented aqueous brew/° P, and more particularly about 1,000,000 cells/ml of unfermented aqueous brew/° P.

The beer may also contain other components in small amounts, such as stabilizers (alginacids, alginate, carrageenan, glycerides, gum Arabic, pectin), artificial sweetening agents, flavoring agents (e.g., wild rosemary, coriander, ginger, anise seed, juniper berries, wood bark), coloring agents, vitamins, minerals, preservatives, effervescence generating agents, antioxidants (e.g., Chr. Hansen and Sodium available from Crosby & Baker Ltd, Westport, Massachusetts and Vitamin C, Vitamin E and selenium), fining agents (e.g., Allfine from Alltech, Biofine, Gelatin, PolyCar 10 and Sparkolloid, available from Crosby & Baker Ltd, Westport, Mass.), silica gels (e.g., Millennium SiL-PROOF BG6 ZeroGel available from Crosby & Baker Ltd, Westport, Mass.) and enzymes, particularly protein degrading enzymes and carbohydrate degrading enzymes.

The method of making gluten-free beer begins with the composition of the brew. In one embodiment, a high maltose syrup from gluten-free cereals or grains is added to water in a brew kettle and mixed until completely dissolved. To facilitate dissolution of the syrup, the water may be heated prior to the addition of syrup. A suitable temperature range for the water may be about 40° F. to about 212° F., particularly 120° F. to about 212° F. The amount of fermentable sugar and water should be adjusted accordingly to yield a specific gravity reading between about 6 degrees Plato (° P) to about 18° P. In one embodiment, the specific gravity reading is between about 12° P and about 13° P. Brewing salts, such as CaCl₂, CaSO₄ and MgSO₄, are added to the water prior to or during the addition of syrup. Additionally, pH adjusting agents such as lactic acid and calcium carbonate may be added as well.

The brew is then boiled for about ½ to about 2 hours. During the boiling process, yeast nutrients, protein coagulants and hops are added to the brew. These ingredients may be added at any time during the boiling process. In one embodiment in which a brew is boiled for one hour, the yeast nutrients and protein coagulants are added 30 minutes into the boiling process and the hops are added near the end of the boiling process. After the boiling process, the heat is removed and the brew is allowed to sit for a period of time to let particulate matter settle to the bottom of the kettle. The brew is then carefully decanted from the kettle into a heat exchanger so as to leave any particulate matter behind. The heat exchanger chills the brew to a temperature of about 45° F. to about 80° F., particularly about 60° F. to about 70° F., and more particularly to about 65° F. The chilled brew is then transferred to a first fermentation tank.

Yeast is added to a first fermentation tank and the brew is allowed to ferment for a period of about 4 to about 14 days. In one embodiment, the first fermentation tank is a closed system but not under pressure. The temperature during the first fermentation will vary depending upon whether the desired beer is an Ale or Lager. Ales typically ferment at about 60° F. to about 72° F. Lagers typically ferment at about 38° F. to about 50° F. After about 10 days, the brew is transferred to a second fermentation tank where the solution is chilled to about 30° F. to about 40° F. In one embodiment, the second fermentation tank is a closed system but not under pressure. The brew remains in the second fermentation tank for about one to about four weeks, after which the resultant beer is then filtered, carbonated and packaged as gluten-free beer

After the second fermentation, the beer may appear somewhat cloudy from yeast cells and other particles that remain suspended in the liquid. The most common method of removing these impurities is filtration, a process in which the finished beer is pumped, under pressure, through a filtering system that traps nearly all of the suspended particles from the liquid, resulting in a clear liquid. Even after filtration, however, some yeast may remain in the beer. To kill the remaining yeast, the beer may be pasteurized, or heated to 82° C. (180° F.) after it has been sealed in cans or bottles.

Although the above process uses a gluten-free syrup from a single source of grain or cereal, it should be understood by those skilled in the art that the process may be used to make beer from more than one gluten-free grain or cereal. In one embodiment, a beer is made by combining a high maltose rice syrup and a high maltose sorghum syrup in the pre-boil brew. In another embodiment, a beer is made by combining a first boiled brew containing a high maltose rice syrup with a second boiled brew containing a high maltose sorghum syrup just prior to the first fermentation. In a further embodiment, a beer is made by combining a first boiled brew containing a high maltose rice syrup with a second boiled brew containing a high maltose sorghum syrup just prior to the second fermentation.

Beers made by this method are found to be substantially free of glutens. Most samples that were tested showed gluten concentration levels below the 10 ppm detection limit.

Examples embodying the invention are provided below. The examples are illustrative of the invention and are not meant to be limiting.

### EXAMPLES

### Example 1

### Gluten-Free Beer Made from Rice Cereal and Grain Sorghum

A quantity of 52 barrels of water were added to a brew kettle and heated to about 200° F. 950 grams of CaCl₂ were added to the brewing water. A quantity of 1050 pounds of pure, all-natural, enzyme-produced, high maltose rice syrup (available from Briess™ Malt & Ingredients Co., Chilton, Wis.) were added to the brew kettle and mixed with the salt water until the syrup was completely dissolved. An amount of 1050 pounds of pure, all-natural, enzyme-produced, high maltose syrup produced from the starchy heads of grain sorghum (available from Briess™ Malt & Ingredients Co., Chilton, Wis.) were added to the brew kettle and mixed with the water until the syrup was completely dissolved. The desired specific gravity of the contents of the brew kettle, or brew, at this point is about 12.5 degrees Plato. If that was not the case, the combinations of water, rice syrup and sorghum syrup were adjusted accordingly to yield a specific gravity of about 12.5 degrees Plato.

The kettle was heated to boiling for about one hour. About half-way through the boiling process, 350 grams of Yeastex (available from Crosby & Baker Ltd, Westport, Mass.) and 225 grams of carrageenan were added to the brew. About 2 minutes before the end of the boil, 1185 grams of Hexahop Gold Hop Extract (available from JOHN I. HAAS, Inc., Yakima, Wash.) and 3500 grams of Cascade (available from Hop Union, Yakima, Wash.) were added to the brew. After one hour of boiling, the heat was removed and the brew left to sit for 15 minutes. The brew (unfermented wort) was then passed through a heat exchanger and chilled to 65° F., after which it was transferred into a fermentation tank. Fermentis SafAle US-56 (available from Crosby & Baker Ltd, Westport, Mass.) was added to the fermentation tank at a quantity of 1,000,000 cells/ml of unfermented wort/° P of the unfermented wort. The wort fermented over the next 10 days, after which time the wort was transferred to a secondary fermentation tank for one week and chilled to 32° F. After a week in the fermentation tank, the resulting beer was filtered, carbonated and packaged. The fermentation yielded a golden ale of typical mild ale style with a pearly head, and a slightly fruity aroma.

### Example 2

### Gluten-Free Beer Made from Rice Cereal

Use the same procedure in Example 1 except substitute the sorghum syrup with an equal amount of the rice syrup (i.e., double the amount of rice syrup in the recipe).

### Example 3

### Gluten-Free Beer Made from Grain Sorghum

Use the same procedure in Example 1 except substitute the rice syrup with an equal amount of the sorghum syrup (i.e., double the amount of sorghum syrup in the recipe).

### Example 4

### Gluten-Free Beer Made from Rice Cereal and Grain Sorghum

Batch A: A pre-boil brew was made by combining water at 200° F., 950 grams CaCl₂ and 2100 pounds of pure, all-natural, enzyme-produced, high maltose rice syrup (available from Briess™ Malt & Ingredients Co., Chilton, Wis.). The pre-boil brew yielded 57.5 barrels of brew having a specific gravity of 12.5 degrees Plato. The brew was boiled for 1 hour. Halfway through the boiling process, 350 grams of Yeastex (available from Crosby & Baker Ltd, Westport, Mass.) and 225 grams of Breakbright (available from Crosby & Baker Ltd, Westport, Mass.) were added. About two minutes before the end of the boil, 1185 grams of Hexahop Gold Hop Extract (available from JOHN I. HAAS, Inc., Yakima, Wash.) and 3500 grams Cascade (available from Hop Union, Yakima, Wash.) were added to the brew. The volume of the post-boil brew was 55.2 barrels.

Batch B: A pre-boil brew was made by combining water at 200° F., 950 grams CaCl₂ and 2100 pounds pure, all-natural, enzyme-produced, high maltose syrup produced from the starch heads of grain sorghum (available from Briess™ Malt & Ingredients Co., Chilton, Wis.). The pre-boil brew yielded 57.5 barrels of brew having a specific gravity of 12.3 degrees Plato. The brew was boiled for 1 hour. Halfway through the boiling process, 350 grams of Yeastex (available from Crosby & Baker Ltd, Westport, Mass.) and 225 grams of Breakbright (available from Crosby & Baker Ltd, Westport, Mass.) were added. About two minutes before the end of the boil, 1185 grams of Hexahop Gold Hop Extract (available from JOHN I. HAAS, Inc., Yakima, Wash.) and 3500 grams Cascade (available from Hop Union, Yakima, Wash.) were added to the brew. The volume of the post-boil brew was 52.5 barrels.

Equal amounts of Batch A and Batch B were then combined in a fermentation tank as unfermented wort. Fermentis SafAle US-56 (available from Crosby & Baker Ltd, Westport, Mass.) was added to the fermentation tank at a quantity of 1,000,000 cells/ml of unfermented wort/° P of the unfermented wort. The unfermented wort fermented over the next 10 days, after which time the wort was transferred to a secondary fermentation tank for one week and chilled to 32° F. After a week in the fermentation tank, the resulting beer was filtered, carbonated and packaged.

### Example 5

### Gluten-Free Beer Made from Rice Cereal and Grain Sorghum

A quantity of 47 barrels of water were added to a brew kettle and heated to about 200° F. 2000 grams of CaCl₂ were added to the brewing water. A quantity of 2100 pounds of pure, all-natural, enzyme-produced, high maltose rice syrup (available from Briess™ Malt & Ingredients Co., Chilton, Wis.) were added to the salt water in the brew kettle and mixed until the syrup was completely dissolved. The specific gravity of the contents of the brew kettle, or sweet wort, was about 12.5° P.

The kettle was heated to boiling for about one hour. About half-way through the boiling process, 350 grams of Yeastex (available from Crosby & Baker Ltd, Westport, Mass.) and 225 grams of carrageenan were added to the brew. Two minutes before the end of the boil, 5000 grams of Cascade hops (available from Hop Union, Yakima, Wash.) were added to the brew. After one hour of boiling, the heat was removed and the brew left to sit for 15 minutes to let particulate settle. The brew (unfermented wort) was then passed through a heat exchanger and chilled to 65° F., after which it was transferred into a fermentation tank. Fermentis SafAle US-56 (available from Crosby & Baker Ltd, Westport, Mass.) was added to the fermentation tank at a quantity of 1,000,000 cells/ml of unfermented wort/° P of the unfermented wort.

The above process was then repeated, except that the high maltose rice syrup was replaced with high maltose sorghum syrup (available from Briess™ Malt & Ingredients Co., Chilton, Wis.). The rice batch and sorghum batch were each fermented separately.

After two weeks, both batches were transferred and combined into another fermentation tank and chilled to about 30° F. to about 38° F., and allowed to sit for about one to about four weeks. After this time, the beer was transferred to the carbonation tank. Along the way of the transfer, the beer was first injected with Tetrahop Gold Hop Extract (available from JOHN I. HAAS, Inc., Yakima, Wash.) at the concentration of 8.72 grams/finished barrel, and then filtered before proceeding into the carbonation tank. After the beer was carbonated, the beer was packaged. The finished product yielded a golden English Ale with a pearly head, and a slightly fruity aroma.

### Example 6

### Gluten-Free Beer Made from Rice Cereal and Grain Sorghum

The ingredients and quantities used in making the beer are summarized in Table 1.

TABLE 1

| | | |
|---|---|---|
| Sorghum Syrup (available from Briess ™ Malt & | 75 | gallons |
| Ingredients Co., Chilton, Wisconsin) | | |
| Rice Syrup (available from Briess ™ Malt & | 25 | gallons |
| Ingredients Co., Chilton, Wisconsin) | | |
| Cascade Hops (available from Hop Union, | 12 | pounds |
| Yakima, Washington) | | |
| Water | 500 | gallons |
| Fermentis SafAle US-56 Yeast (available from | 2.5 | pounds |
| Crosby & Baker Ltd, Westport, Massachusetts) | | |

The water was heated to boiling. The sorghum and rice syrups were added to the boiling water. After 5 minutes of boiling the syrup/water combination, the hops were added. The brew mixture was boiled for an additional hour and removed from the heat. The mixture was passed through a heat exchanger to cool the brew to room temperature and the brew was transferred to a fermentation tank. The yeast was added to the brew and the brew fermented for 10 days. After 10 days, the temperature of the brew was lowered to 34° F. and the brew was allowed to mature for 7 more days. The resultant beer was filtered, carbonated and packaged into bottles and kegs. The approximate alcohol content was 4.8% by volume.

### Example 7

### Gluten-Free Beer Made from Grain Sorghum

The ingredients and quantities used in making the beer are summarized in Table 2.

TABLE 2

| | | |
|---|---|---|
| Sorghum Syrup (available from Briess ™ Malt & | 75 | gallons |
| Ingredients Co., Chilton, Wisconsin) | | |
| Cascade Hops (available from Hop Union, | 12 | pounds |
| Yakima, Washington) | | |
| Water | 500 | gallons |
| Fermentis SafAle US-56 Yeast (available from | 2.5 | pounds |
| Crosby & Baker Ltd, Westport, Massachusetts) | | |

The water was heated to boiling. The sorghum syrup was added to the boiling water. After 5 minutes of boiling the syrup/water combination, the hops were added to the boiling water. The brew mixture was boiled for an additional hour and removed from the heat. The mixture was passed through a heat exchanger to cool the brew to room temperature and the brew was transferred to a fermentation tank. The yeast was added to the brew and the brew fermented for 10 days. After 10 days, the temperature of the brew was lowered to 34° F. and the brew was. allowed to mature for 7 more days. The resultant beer was filtered, carbonated and packaged into bottles and kegs. The approximate alcohol content was 4.8% by volume.

### Example 8

### Gluten-Free Beer Made from Rice Cereal

The ingredients and quantities used in making the beer are summarized in Table 3.

TABLE 3

| | | |
|---|---|---|
| Rice Syrup (available from Briess ™ Malt & | 75 | gallons |
| Ingredients Co., Chilton, Wisconsin) | | |
| Cascade Hops (available from Hop Union, | 12 | pounds |
| Yalcima, Washington) | | |
| Water | 500 | gallons |
| Fermentis SafAle US-56 Yeast (available from | 2.5 | pounds |
| Crosby & Baker Ltd, Westport, Massachusetts) | | |

The water was heated to boiling. The rice syrup was added to the boiling water. After 5 minutes of boiling the syrup/water combination, the hops were added. The brew mixture was boiled for an additional hour and removed from the heat. The brew was passed through a heat exchanger to cool the brew to room temperature and then transferred to a fermentation tank. The yeast was added to the brew and fermented for 10 days. After 10 days, the temperature of the brew was lowered to 34° F. and the brew allowed to mature for 7 more days. The resultant beer was filtered, carbonated and packaged into bottles and kegs.

1. A method of making a substantially gluten-free beer, the method comprising:
dissolving an enzyme-produced maltose syrup derived from at least one of rice, sorghum or combination thereof in water to produce an aqueous solution;
adding a yeast nutrient, a protein coagulant and hops to the aqueous solution to form an aqueous brew; and
fermenting the aqueous brew by the addition of yeast to produce a substantially gluten-free beer.

2. The method of claim 1, wherein the syrup is derived from sorghum.

3. The method of claim 1, wherein the syrup is derived from rice.

4. The method of claim 1, wherein the syrup is derived from rice and sorghum.

5. The method of claim 1, wherein the aqueous solution has a specific gravity of between about 6° P and about 18° P.

6. The method of claim 1, wherein the aqueous solution has a specific gravity of between about 12° P to about 13° P.

7. The method of claim 1, wherein the aqueous solution further comprises a brewing salt.

8. The method of claim 1, wherein the aqueous solution is boiled for about ½ to about 2 hours.

9. The method of claim 8, wherein the yeast nutrients and protein coagulants are added to the aqueous solution about half way through the boiling process.

10. The method of claim 8, wherein the aqueous brew is chilled to about 45° F. to about 80° F. before adding the yeast.

11. The method of claim 1, wherein yeast is added to the aqueous brew at a quantity of about 500,000 to about 1,500,000 cells/ml of aqueous brew/° P of the aqueous brew.

12. The method of claim 1, wherein the substantially gluten-free beer comprises at least one of stabilizers, artificial sweetening agents, flavoring agents, coloring agents, vitamins, minerals, preservatives, effervescence generating agents, antioxidants and enzymes.

13. The method of claim 1, wherein fermenting comprises a first fermentation lasting about 4 to about 14 days followed by a second fermentation lasting about 1 to about 4 weeks.

14. The method of claim 13, wherein the first fermentation is carried out at about 60° F. to about 72° F.

15. The method of claim 13, wherein the first fermentation is carried out at about 38° F. to about 50° F.

16. The method of claim 15, wherein the second fermentation is carried out at about 30° F. to about 40° F.

17. The method of claim 1, wherein the substantially gluten-free beer comprises less than about 10 ppm gluten.

18. A method of making a substantially gluten-free beer comprising:
dissolving an enzyme-produced maltose syrup derived from rice in water to produce a first aqueous solution and adding a yeast nutrient, a protein coagulant and hops to the aqueous solution to form a first aqueous brew;
dissolving an enzyme-produced maltose syrup derived from sorghum in water to produce a second aqueous solution and adding a yeast nutrient, a protein coagulant and hops to the aqueous solution to form a second aqueous brew;
combining the first aqueous brew and the second aqueous brew to produce a combined aqueous brew; and
fermenting the combined aqueous brew by the addition of yeast to produce a substantially gluten-free beer.

19. (canceled)

20. (canceled)

21. (canceled)

22. (canceled)

23. The method of claim 18, wherein the ratio of syrup derived from rice and syrup derived from sorghum ranges from about 2:8 to about 8:2.

24. The method of claim 18, wherein the ratio of syrup derived from rice and syrup derived from sorghum ranges from about 4:6 to about 6:4.

25. (canceled)

26. (canceled)

27. (canceled)

28. (canceled)

29. The method of claim 18, wherein the substantially gluten-free beer comprises less than about 10 ppm gluten.

30. A substantially gluten-free beer comprising fermented sugars from sorghum and rice.

31. The substantially gluten-free beer of claim 30, wherein the beer contains less than about 10 ppm gluten.

32. The substantially gluten-free beer of claim 30, wherein the beer contains about 4.8% alcohol.

33. (canceled)

34. A substantially gluten-free beer derived from fermentation of an aqueous brew, the aqueous brew comprising:
maltose sorghum syrup and maltose rice syrup;
a yeast nutrient;
a protein coagulant; and
hops.

35. The substantially gluten-free beer of claim 34, wherein the specific gravity of the aqueous brew is between about 6° P and about 18° P.

36. (canceled)

37. (canceled)

38. (canceled)

39. (canceled)

40. The substantially gluten-free beer of claim 34, wherein the beer contains less than about 10 ppm gluten.

41. The method of claim 34, wherein the ratio of maltose sorghum syrup and maltose rice syrup ranges from about 2:8 to about 8:2.

42. The method of claim 34, wherein the ratio of maltose sorghum syrup and maltose rice syrup ranges from about 4:6 to about 6:4.

43. A method of providing a substantially gluten-free beer to an individual suffering from Celiac disease, the method comprising:
fermenting an aqueous brew comprising maltose sorghum syrup, maltose rice syrup, a yeast nutrient, a protein coagulant, and hops to produce a substantially gluten-free beer; and
providing the substantially gluten-free beer to the individual suffering from Celiac disease.

44. (canceled)

45. (canceled)

46. (canceled)

47. (canceled)

48. (canceled)

49. The method of claim 43, wherein the beer contains less than about 10 ppm gluten.

50. The method of claim 43, wherein the ratio of fermentable sugars derived from rice and sorghum ranges from about 2:8 to about 8:2.

51. The method of claim 43, wherein the ratio of fermentable sugars derived from rice and sorghum ranges from about 4:6 to about 6:4.

52. A method of making a substantially gluten-free beer comprising:
dissolving an enzyme-produced maltose syrup derived from rice in water to produce a first aqueous solution and adding a yeast nutrient, a protein coagulant and hops to the aqueous solution to form a first aqueous brew;
dissolving an enzyme-produced maltose syrup derived from sorghum in water to produce a second aqueous solution and adding a yeast nutrient, a protein coagulant and hops to the aqueous solution to form a second aqueous brew;
carrying out a first fermentation on each of the first aqueous brew and the second aqueous brew by the addition of yeast;
combining the fermented first aqueous brew and the fermented second aqueous brew to produce a combined fermented aqueous brew; and
carrying out a second fermentation on the combined first fermented aqueous brew to produce a substantially gluten-free beer.

53. (canceled)

54. (canceled)

55. (canceled)

56. (canceled)

57. The method of claim 52, wherein the ratio of syrup derived from rice and syrup derived from sorghum ranges from about 2:8 to about 8:2.

58. The method of claim 52, wherein the ratio of syrup derived from rice and syrup derived from sorghum ranges from about 4:6 to about 6:4.

59. (canceled)

60. (canceled)

61. (canceled)

62. (canceled)

63. The method of claim 52, wherein the substantially gluten-free beer comprises less than about 10 ppm gluten.
